(19) United States
(12) Patent Application Publication
(10) Pub. No.: US 2011/0078904 A1
(43) Pub. Date: Apr. 7, 2011

(54) Conduit Cutter

(75) Inventor: Luigi Edmondo Lucente, Steger, IL (US)

(73) Assignee: ETCON CORP., Burr Ridge, IL (US)

(21) Appl. No.: 12/573,243

(22) Filed: Oct. 5, 2009

(51) Int. Cl. B26D 7/06; B26B 27/00

(52) U.S. Cl. 30/92; 30/374

(57) ABSTRACT

A portable conduit cutter for attaching to a power tool is disclosed. The portable conduit cutter includes a plate for use in attaching the conduit cutter to the different power tools. The plate may be adapted to fit different power tools depending upon the attachment requirements of the particular power tool. A compression spring and spring can assembly may be attached to a jaw slide and used to allow the jaw slide to move parallel with respect to the plate.

### FIELD OF THE INVENTION

The disclosure relates to a conduit cutter for cutting electrical conduit. More particularly, the disclosure concerns an attachment for a device such as a reciprocating saw to cut pipe or electrical conduit.

### BACKGROUND

Electricians and do it yourself (DIY) owners performing electrical installations and/or electrical remodeling work at some phase usually need to install and/or modify electrical conduit routings. Current methods of cutting metallic electrical conduit involve using devices that are positioned or placed on a workbench or other ground level surface. Other known manual devices for cutting electrical conduit include a manual conduit cutter and/or a hacksaw. Though the manual conduit cutter and hacksaw are portable devices, a significant amount of room is needed to utilize these devices. In tight or overhead locations, use of a manual conduit cutter and/or hacksaw is difficult. Furthermore, use of a manual conduit cutter may be time consuming and include excessive physical exertion which may be additive and tiring for the user if numerous cuts have to be made over a short time period.

Currently, for overhead and tight locations electricians or other workers having to install conduit may carry portions of conduit that need to be cut to a physical location where cutting may take place with adequate space for the selected cutting tool. However, physically transporting sections of conduit to be cut to another area is time consuming and in some locations not practical. For example, an electrician working on a scaffold having to come down off of the scaffold to ground level with a piece of conduit that needs to be cut is a significant waste of man-hours.

Therefore, there is a need in the art for a portable conduit cutter that may be removably attached to a power tool for use in tight locations having limited space for cutting.

### SUMMARY

One or more of the above-mentioned needs in the art are satisfied by the disclosed conduit cutter of the present disclosure. The conduit cutter may be a portable device removably attachable to different power tools such as a reciprocating saw.

The portable conduit cutter may include a plate for use in attaching the conduit cutter to the different power tools. The plate may be adapted to fit different power tools depending upon the attachment requirements of the particular power tool.

In an aspect of the disclosure, a portable conduit cutter may include a jaw attached to a jaw slide for securing a piece of conduit or pipe for cutting. A compression spring and spring can assembly may be attached to the jaw slide and used to allow the jaw slide to move parallel with respect to the plate. The compression spring and spring can assembly along with a spring latch may be used to secure the conduit in the jaw and hold the jaw slide in a loading position prior to cutting the conduit or pipe.

Upon activation of the power tool, the jaw slide moves to a finished position after cutting through the conduit or pipe.

The advantages and features of novelty characterizing the present invention are pointed out with particularity in the appended claims. To gain an improved understanding of the advantages and features of novelty, however, reference may be made to the following descriptive matter and accompanying drawings that describe and illustrate various embodiments and concepts related to the invention.

### DESCRIPTION OF THE DRAWINGS

The present disclosure is illustrated by way of example and not limited in the accompanying figures in which like reference numerals indicate similar elements and in which:

FIG. 1 illustrates a side view of a conduit cutter in a loading position attached to a reciprocating saw in accordance with an aspect of the disclosure;

FIG. 2 illustrates another side view of a conduit cutter in a finished position attached to a reciprocating saw in accordance with an aspect of the disclosure;

FIG. 3 illustrates a front view of a conduit cutter in a finished position attached to a reciprocating saw in accordance with an aspect of the disclosure;

FIG. 4 illustrates detailed front and side views of components of a conduit cutter in accordance with an aspect of the disclosure; and

FIG. 5 illustrates an expanded side view of a conduit cutter in a finished position attached to a reciprocating saw in accordance with an aspect of the disclosure.

### DETAILED DESCRIPTION

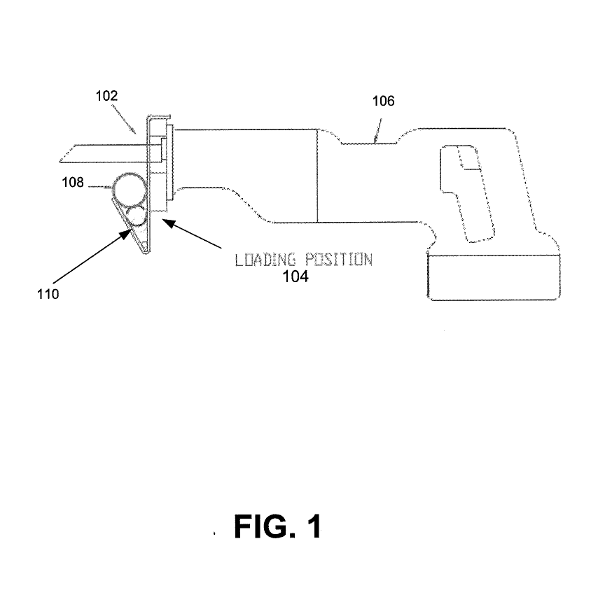

The following discussion and accompanying figures disclose various embodiments of a conduit cutter in accordance with various aspects of the disclosure. Referring to FIG. 1, a conduit cutter 102 is illustrated in a loading position 104 attached to a reciprocating saw 106 in accordance with an aspect of the disclosure. In an embodiment, conduit cutter 102 may be in the form of an attachment that may be removably attached to various cutting devices such as reciprocating saw 106. Those skilled in the art will realize that conduit cutter 102 may be adapted to attach to different manufactures of power equipment by changing the attachment mechanism to accommodate different manufactures attachment specifications. In addition, conduit cutter 102 may also be adapted for use with different power tools such a jig saw. Those skilled in the art will realize that the attachment mechanism is defined by the tool being used and that different attachment configurations may be utilized so that conduit cutter 102 may be universally used on different power devices.

Referring back to FIG. 1, conduit cutter 102 is shown in loading position 104. Loading position 104 secures a piece of conduit 108 in a locked position using jaw 110. Jaw 110 may accommodate conduits of various sizes such as half inch up to and including three inch as illustrated in FIG. 1. Those skilled in the art will realize that jaw 110 may be sized to secure in place the maximum sized conduit an attached power tool may cut based on its nameplate power rating. In other embodiments of the disclosure, conduit cutter 108 may be configured to cut smaller or larger diameter conduits or pipes.

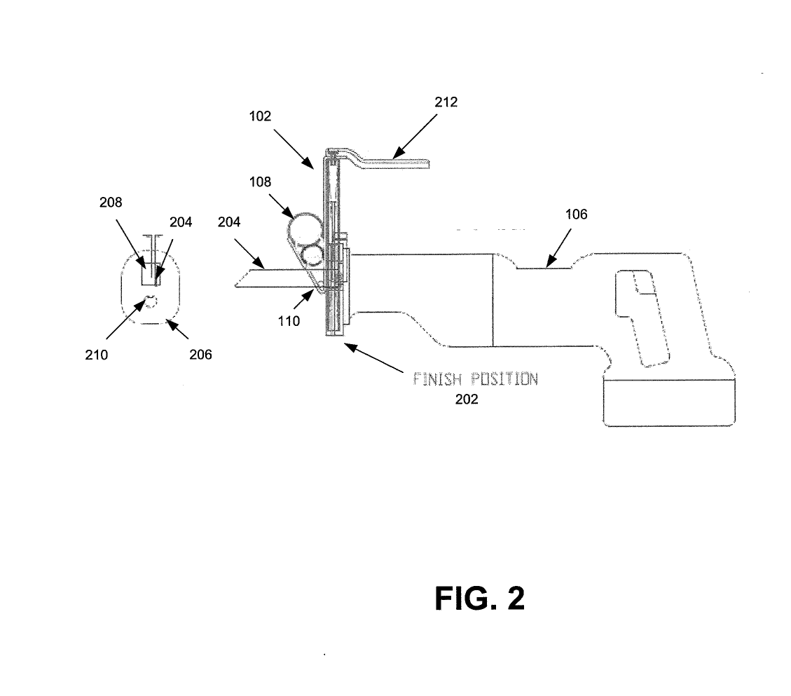

FIG. 2 illustrates a side view of a conduit cutter 102 in a finished position 202 attached to a reciprocating saw 106 in accordance with an aspect of the disclosure. Finished position 202 is illustrated by cutting blade 204 having cut through a conduit 108 and the bottom portion of jaw 110 being in close proximity to blade 204 as compared to the blade position shown in the loading position 104 of FIG. 1.

In an aspect of the disclosure, conduit cutter 102 may be removably attached to various power cutting devices such as reciprocating saw 106. For instance, FIG. 2 further illustrates a front view of a mounting plate 206 that may be representative of a mounting plate found on a typical reciprocating saw 106. The mounting plate 206 may have an aperture 208 through which blade 204 may pass and be secured to reciprocating saw 106. As shown in the mounting plate 206 of FIG. 2, blade 204 may be off centered as it passes through aperture 208 per the reciprocating saws manufacturer's specifications. A slot 210 may be located on mounting plate 206 for securing attachments such as conduit cutter to reciprocating saw 106. Those skilled in the art will realize that conduit cutter 102 may include different attachment mechanisms so that conduit cutter 102 may be attached to different power tools (or attached to other structural features located on different brands of reciprocating saws) and allow for proper blade 204 positioning.

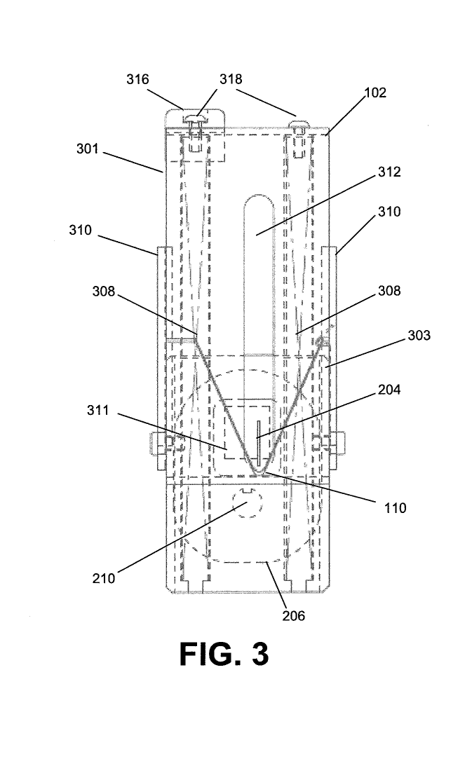

FIG. 3 illustrates a front view of conduit cutter 102 in a finished position attached to a reciprocating saw 106 in accordance with an aspect of the disclosure. In accordance with an aspect of the disclosure, conduit cutter 102 may include a jaw slide 301. Jaw slide 301 may be able to move with respect to plate 303 in a parallel direction so that conduit cutter 102 may transition from a loading position to a finished position. In an embodiment, compression springs 308 may be housed in spring cans 310 located on plate 303. Those skilled in the art will realize that the use of compression springs 308 and spring cans 310 enable conduit cutter 102 to hold in place the piece of conduit to be cut. Also, in an embodiment, the use of compression springs 308 and spring cans 310 enables an operator of the conduit cutter to cut conduit without having to hold the conduit in place. This feature allows for working in tight places or overhead as the conduit cutter 102 holds the conduit to be cut in a fixed position for a precise cut.

In FIG. 3, a handle 316 may be attached to conduit cutter 102 via screws 318. In an aspect of the disclosure, handle 316 may be mounted on either side of conduit cutter 102 for use by either left handed or righted hand operators. The handle 316 may be used to hold the conduit cutter 102 in place and/or assist in latching jaw slide 301 into loading position 104 (FIG. 1).

FIG. 3 further illustrates in at least one embodiment of the disclosure, attachment of conduit cutter 102 to reciprocating saw 106. Mounting plate 206 of reciprocating saw 106 may have an aperture 208 (FIG. 2) through which blade 204 may pass. Similarly, plate 303 and jaw slide 301 may include apertures (311 and 312) through which blade 204 protrudes through to enable cutting of a positioned piece of conduit. As shown in FIG. 3, blade 204 may be off centered as it passes through apertures 208, 310, and 312. The placement of blade 204 is dependent upon the power tools manufacturer's specifications. Slot 210 may be located on mounting plate 206 for securing conduit cutter 102.

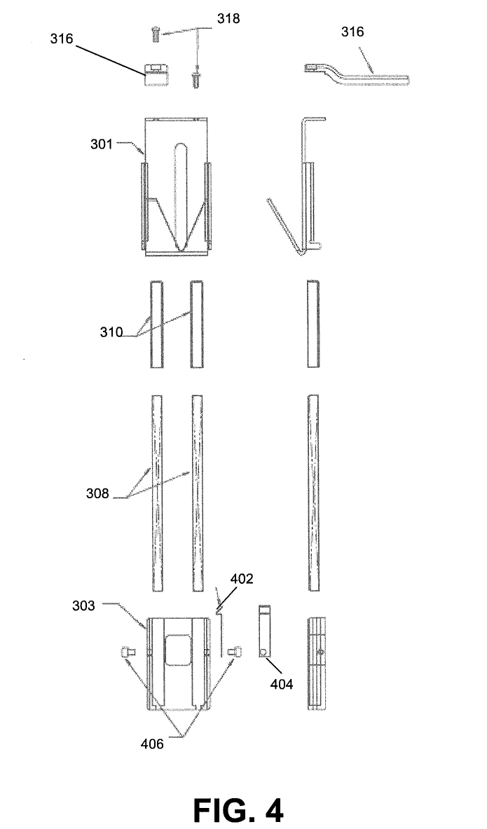

FIG. 4 illustrates detailed front and side views of conduit cutter 102 in accordance with an aspect of the disclosure. In FIG. 4, the front and side views represent various components that may be used in assembly of conduit cutter 102. For instance, conduit cutter may comprise but is not limited to components such as handle 316, screws 318, jaw slide 301, spring cans 310, compression springs 308, and plate 303. In an embodiment of the disclosure, jaw slide 301, spring cans 310, and plate 303 may be comprised of different materials such as steel, titanium, aluminum, tungsten, graphite, polymers, or composites. For instance, in an embodiment jaw slide 301 may be composed of titanium but jaw 110 may be made from tungsten. As those skilled in the art will realize, each component may be made from different materials which include thermoplastic composite materials

In addition, FIG. 4 further illustrates that a spring latch 402 may be used to latch jaw slide 301 into loading position 104. In an embodiment, a jaw slide stop mechanism 404 may also be used so that jaw slide 301 does not over extend compression springs 308. Overextending compression springs 308 may shorten their rated life span. Screws 406 may be used to hold spring latch 402 and/or jaw slide stop mechanism 404 in position.

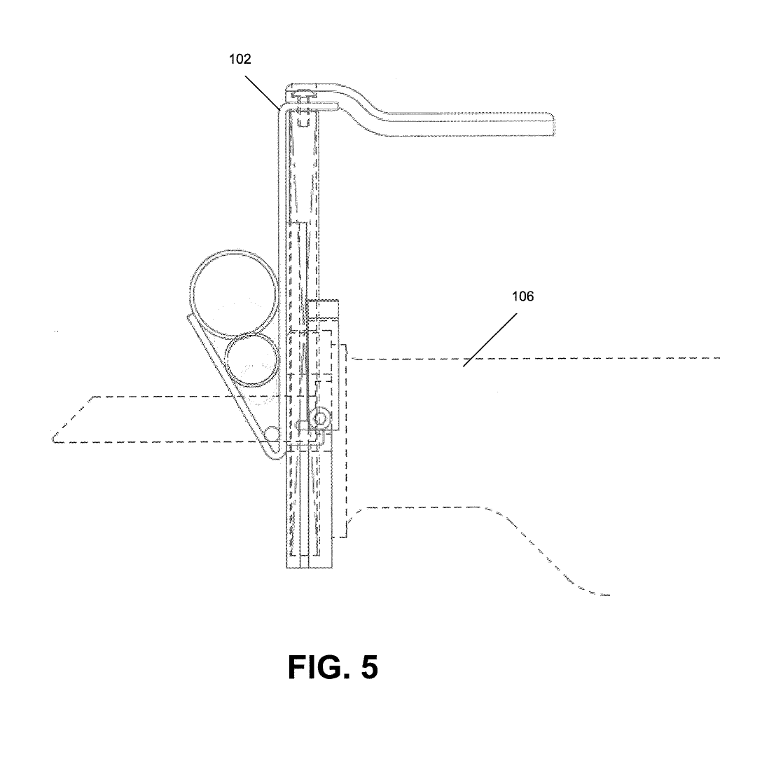

FIG. 5 illustrates an expanded side view of a conduit cutter 102 in a finishing position attached to a reciprocating saw 106 in accordance with an aspect of the disclosure.

The present invention is disclosed above and in the accompanying drawings with reference to a variety of embodiments. The purpose served by the disclosure, however, is to provide an example of the various features and concepts related to the invention, not to limit the scope of the invention. One skilled in the relevant art will recognize that numerous variations and modifications may be made to the embodiments described above without departing from the scope of the present invention, as defined by the appended claims.

I claim:

1. A portable conduit cutter comprising:
a plate configured to be removably attached to a power tool;
a jaw slide;
a jaw for positioning a piece of conduit to be cut, the jaw attached to the jaw slide; and
a compression spring and spring can assembly attached to the jaw slide, the compression spring and spring can assembly configured to allow the jaw slide to move parallel with respect to the plate in order to cut the piece of conduit positioned in the jaw.

2. The portable conduit cutter of claim 1, wherein the portable conduit cutter further comprises a spring latch configured to secure the jaw slide in a loading position.

3. The portable conduit cutter of claim 1, wherein the jaw slide is configured to secure at least up to and including a three inch conduit.

4. The portable conduit cutter of claim 1 wherein the plate is adaptable to fit different power tools.

5. The portable conduit cutter of claim 4, further including a latch jaw slide to hold the jaw slide in a loading position.

6. The portable conduit cutter of claim 5, further including a jaw slide stop mechanism to limit the travel of the jaw slide.

7. The portable conduit cutter of claim 1, wherein the jaw slide further comprises an aperture to attach a cutting blade.

8. The portable conduit cutter of claim 1, wherein the power tool comprises a reciprocating saw.

9. The portable conduit cutter of claim 1, wherein the power tool comprises a jig saw.

10. The portable conduit cutter of claim 1, wherein the slide jaw and jaw are comprised of different materials.

11. A portable pipe cutter comprising:
a plate configured to be removably attached to a power tool;
a jaw slide;
a jaw for positioning a piece of pipe to be cut, the jaw attached to the jaw slide; and
a plurality of compression springs and spring can assemblies attached to the jaw slide, the compression springs and spring can assemblies configured to allow the jaw slide to move parallel with respect to the plate in order to cut the piece of pipe positioned in the jaw.

12. The portable pipe cutter of claim 11, wherein the pipe comprises electrical conduit.

13. The portable pipe cutter of claim 11, wherein the portable pipe cutter further comprises a spring latch configured to secure the jaw slide in a loading position.

14. The portable pipe cutter of claim 11, wherein the plate is adaptable to fit different power tools.

15. The portable pipe cutter of claim 11, further including a latch jaw slide to hold the jaw slide in a loading position.

16. A portable conduit cutter comprising:
an adaptable plate configured to be removably attached to a power tool;
a jaw slide;
a jaw for positioning a piece of conduit to be cut, the jaw attached to the jaw slide;
at least one compression spring and spring can assembly attached to the jaw slide, the at least one compression spring and spring can assembly configured to allow the jaw slide to move parallel with respect to the plate in order to cut the piece of pipe positioned in the jaw; and
a spring latch configured to secure the jaw slide in a loading position.

17. The portable conduit cutter of claim 16, further including a latch jaw slide to hold the jaw slide in a loading position.

18. The portable conduit cutter of claim 17, further including a jaw slide stop mechanism to limit the travel of the jaw slide.

19. The portable conduit cutter of claim 16, wherein the jaw slide further comprises an aperture to attach a cutting blade.

20. The portable conduit cutter of claim 16, wherein the power tool comprises a reciprocating saw.
